(19) United States
(12) Patent Application Publication
(10) Pub. No.: US 2020/0110915 A1
(43) Pub. Date: Apr. 9, 2020

(54) SYSTEMS AND METHODS FOR CONDUCTING MULTI-TASK ORIENTED DIALOGUES

(71) Applicant: FOUND INTELLIGENCE TECHNOLOGY CO., LTD., Hangzhou (CN)

(72) Inventors: Zhixiong LONG, Hangzhou (CN); Yiwei ZHAO, Hangzhou (CN); Xiaosheng DAI, Hangzhou (CN); Liang XU, Hangzhou (CN); Qianping PENG, Hangzhou (CN)

(73) Assignee: FOUND INTELLIGENCE TECHNOLOGY CO., LTD., Hangzhou (CN)

(21) Appl. No.: 16/622,396

(22) PCT Filed: Sep. 27, 2017
(86) PCT No.: PCT/CN2017/103758

§ 371 Date: Dec. 13, 2019

(30) Foreign Application Priority Data
Jun. 14, 2017 (CN) 201710449978.X

(51) Int. Cl. G06F 40/30; G06F 40/284; G06N 3/08; G06N 3/04

(52) U.S. Cl. CPC G06F 40/30; G06F 40/284; G06N 3/0472; G06N 3/0454; G06N 3/088

(57) ABSTRACT

A mufti-task oriented dialogue system may include a storage device storing a set of instructions and a processor in communication with the storage device. When the processor executes the set of instructions, the processor may be configured to cause the system to obtain input information from a user and determine a dialogue state based on the input information. The processor may also be configured to cause the system to obtain a dialogue model for generating one or more actions. The processor may further be configured to cause the system to generate one or more actions based on the dialogue state and the obtained dialogue model. The processor may also be configured to cause the system to execute the generated one or more actions and transmit output information to the user based on an execution result of the one or more actions.

### CROSS-REFERENCE TO RELATED APPLICATIONS

This application claims priority of Chinese Application No. 201710449978.X, filed on Jun. 14, 2017, the content of which is expressly incorporated herein by reference to its entirety.

### TECHNICAL FIELD

The present disclosure generally relates to systems and methods for conducting a dialogue, and in particular, systems and methods for conducting a dialogue with a plurality of turns that each includes a plurality of tasks with a user.

### BACKGROUND

Open-domain spoken dialogue technology and task-oriented spoken dialogue technology are two common technologies in the field of man-machine conversation. Open-domain spoken dialogue technology allows a person to chat with a machine without restrictions on topics and satisfies the person's need for emotional comfort and entertainment. Task-oriented spoken dialogue technology help machine to finish tasks that are given by users. However, it is difficult to implement the two technologies in the same system architecture, and the current man-machine conversation system (e.g., Siri™) can only perform a task in each turn of the dialogue even if multiple tasks are contained in the user's words.

### SUMMARY

In an aspect of the present disclosure, a multi-task oriented dialogue system is provided. The system may include at least one storage device storing a set of instructions and at least one processor in communication with the at least one storage device. When the at least one processor executes the set of instructions, the at least one processor may be configured to cause the system to obtain input information from a user and determine a dialogue state based on the input information. The at least one processor may also be configured to cause the system to obtain a dialogue model for generating one or more actions. The at least one processor may further be configured to cause the system to generate one or more actions based on the dialogue state and the obtained dialogue model. The at least one processor may also be configured to cause the system to execute the generated one or more actions and transmit output information to the user based on an execution result of the one or more actions.

In some embodiments, to determine the state of the input information, the at least one processor may be configured to cause the system to segment the input information into a plurality of tokens and determine the dialogue state based on the plurality of tokens.

In some embodiments, the one or more actions may include at least one of: a sentence-generating action or an API-calling action.

In some embodiments, the one or more actions each may include a name.

In some embodiments, the one or more actions each further may include at least one slot-pair.

In some embodiments, the model for generating one or more actions may be a model based on an Article Neural Network (ANN).

In some embodiments, the model for generating one or more actions is generated by a process of training a model. The process may include obtaining a preliminary model and training data from a dialogue corpus. The process may also include generating actions based on the training data and generating a dialogue model by training the preliminary model based on the actions. The process may further include generating simulated dialogues based on the dialogue model and valuating the generated simulated dialogues. The process may also include updating the dialogue model based on a result of the valuation.

In some embodiments, the at least one processor may be further configured to cause the system to update the dialogue model after a dialogue between the system and the user is finished.

In some embodiments, to update the dialogue model after the dialogue between the multi-tasks oriented system and the user is finished, the at least one processor may be further configured to cause the system to obtain the finished dialogue between the system and the user and perform a first valuation on completeness of one or more tasks in the finished dialogue. The at least one processor may also be configured to cause the system to perform a second valuation on performance of the one or more tasks in the finished dialogue and perform a third valuation on a probability of the finished dialogue being a human dialogue. The at least one processor may further be configured to cause the system to determine a valuation result based on the first valuation, the second valuation, and the third valuation, and update the dialogue model based on the valuation result.

In some embodiments, to execute the generated one or more actions, the at least one processor may be configured to cause the system to execute the generated one or more actions in a sequence. The one or more actions may include a first action and a second action. The first action is executed before the second action, and the second action is executed based on an execution result of the first action.

In some embodiments, the output information may include a request for obtaining new input information.

In another aspect of the present disclosure, a method for conducting a multi-task oriented dialogue is provided. The method may include obtaining input information from a user and determining a dialogue state based on the input information. The method may also include obtaining a dialogue model for generating one or more actions. The method may further include generating one or more actions based on the dialogue state and the obtained dialogue model. The method may also include executing the generated one or more actions, and transmitting output information to the user based on an execution result of the one or more actions.

In yet another aspect of the present disclosure, a non-transitory computer readable medium including executable instructions is provided. When the executable instructions are executed by at least one processor, the non-transitory computer readable medium may cause the at least one processor to effectuate a method. The method may include obtaining input information from a user and determining a dialogue state based on the input information. The method may also include obtaining a dialogue model for generating one or more actions. The method may further include generating one or more actions based on the dialogue state and the obtained dialogue model. The method may also include executing the generated one or more actions, and transmitting output information to the user based on an execution result of the one or more actions.

### BRIEF DESCRIPTION OF THE DRAWINGS

The present disclosure is further described in terms of exemplary embodiments. These exemplary embodiments are described in detail with reference to the drawings. The drawings are not to scale. These embodiments are non-limiting schematic embodiments, in which like reference numerals represent similar structures throughout the several views of the drawings, and wherein:

FIG. 1 is a schematic diagram illustrating an exemplary multi-task oriented dialogue system according to some embodiments of the present disclosure;

FIG. 2 is a schematic diagram illustrating exemplary hardware and/or software components of a computing device according to some embodiments of the present disclosure;

FIG. 3 is a block diagram illustrating an exemplary processing engine according to some embodiments of the present disclosure;

FIG. 4 is a flowchart illustrating an exemplary process for conducting a dialogue according to some embodiments of the present disclosure;

FIG. 5 is a block diagram illustrating an exemplary model training module according to some embodiments of the present disclosure;

FIG. 6 is a flowchart illustrating an exemplary process for generating a dialogue model according to some embodiments of the present disclosure;

FIG. 7 is a flowchart illustrating an exemplary process for conducting a dialogue according to some embodiments of the present disclosure;

FIG. 8 is a flowchart illustrating an exemplary process for valuating a dialogue according to some embodiments of the present disclosure;

FIG. 9 is a block diagram illustrating an exemplary state determination module according to some embodiments of the present disclosure;

FIG. 10 is a flowchart illustrating an exemplary process for determining a dialogue state based on input information from a user according to some embodiments of the present disclosure; and

FIG. 11 is a flowchart illustrating an exemplary process for executing one or more actions according to some embodiments of the present disclosure.

### DETAILED DESCRIPTION

The following description is presented to enable any person skilled in the art to make and use the present disclosure and is provided in the context of a particular application and its requirements. Various modifications to the disclosed embodiments will be readily apparent to those skilled in the art, and the general principles defined herein may be applied to other embodiments and applications without departing from the spirit and scope of the present disclosure. Thus, the present disclosure is not limited to the embodiments shown, but is to be accorded the widest scope consistent with the claims.

The terminology used herein is for the purpose of describing particular example embodiments only and is not intended to be limiting. As used herein, the singular forms “a,” “an,” and “the” may be intended to include the plural forms as well, unless the context clearly indicates otherwise. It will be further understood that the terms “comprise,” “comprises,” and/or “comprising,” “include,” “includes,” and/or “including,” when used in this specification, specify the presence of stated features, integers, steps, operations, elements, and/or components, but do not preclude the presence or addition of one or more other features, integers, steps, operations, elements, components, and/or groups thereof.

These and other features, and characteristics of the present disclosure, as well as the methods of operation and functions of the related elements of structure and the combination of parts and economies of manufacture, may become more apparent upon consideration of the following description with reference to the accompanying drawings, all of which form a part of this disclosure. It is to be expressly understood, however, that the drawings are for the purpose of illustration and description only and are not intended to limit the scope of the present disclosure. It is understood that the drawings are not to scale.

The flowcharts used in the present disclosure illustrate operations that systems implement according to some embodiments of the present disclosure. It is to be expressly understood, the operations of the flowchart may be implemented not in order. Conversely, the operations may be implemented in inverted order, or simultaneously. Moreover, one or more other operations may be added to the flowcharts. One or more operations may be removed from the flowcharts.

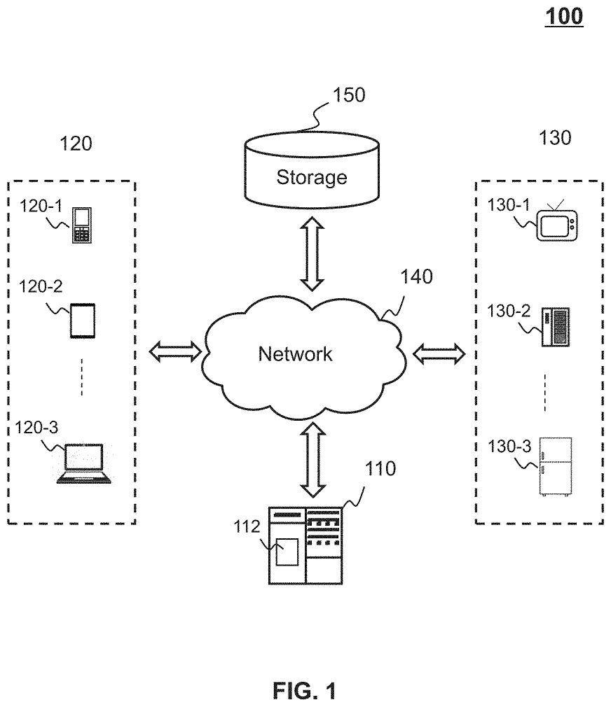

FIG. 1 is a schematic diagram of an exemplary multi-task oriented dialogue system according to some embodiments of the present disclosure. The multi-task oriented dialogue system 100 may be an online platform for conducting one or more dialogues with a user. Each of the dialogues may include a plurality of tasks including hailing a taxi, planning a schedule, inquiring weather, booking a ticket, answering a question, etc. The multi-task oriented dialogue system 100 may include a server 110, a user device 120 (or a user interface connecting to a user device 120), an external device 130 (or an external interface connecting to an external device 130), a network 140, and a storage 150. The server 110 may include a processing engine 112.

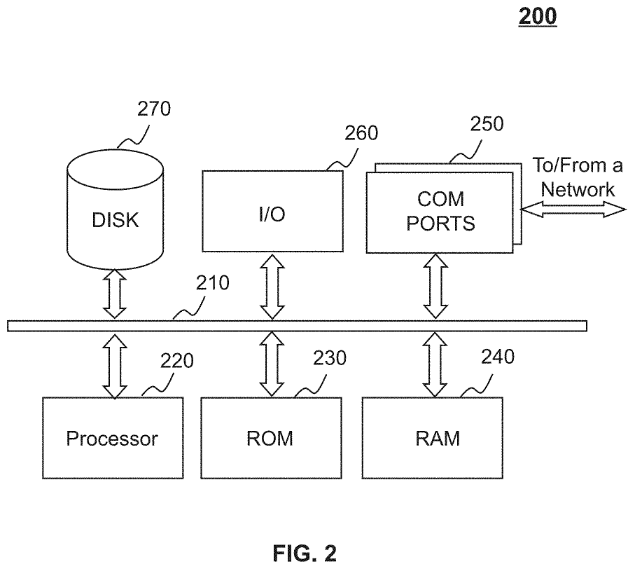

In some embodiments, the server 110 may be a single server or a server group. The server group may be centralized, or distributed (e.g., server 110 may be a distributed system). In some embodiments, the server 110 may be local or remote. For example, the server 110 may access information and/or data stored in the user device 120, the external device 130, and/or the storage 150 via the network 140. As another example, the server 110 may be directly connected to the user device 120, the external device 130, and/or the storage 150 to access stored information and/or data. In some embodiments, the server 110 may be implemented on a cloud platform. Merely by way of example, the cloud platform may include a private cloud, a public cloud, a hybrid cloud, a community cloud, a distributed cloud, an inter-cloud, a multi-cloud, or the like, or any combination thereof. In some embodiments, the server 110 may be implemented on a computing device 200 having one or more components illustrated in FIG. 2 in the present disclosure.

In some embodiments, the server 110 may include a processing engine 112. The processing engine 112 may process information and/or data relating to a dialogue between a user and the multi-task oriented dialogue system 100 described in the present disclosure. For example, the processing engine 112 may determine and execute one or more actions to perform one or more tasks in response to input information obtained from the user device 120. In some embodiments, the processing engine 112 may include one or more processing engines (e.g., single-core processing engine(s) or multi-core processor(s)). Merely by way of example, the processing engine 112 may include one or more hardware processors, such as a central processing unit (CPU), an application-specific integrated circuit (ASIC), an application-specific instruction-set processor (ASIP), a graphics processing unit (GPU), a physics processing unit (PPU), a digital signal processor (DSP), a field-programmable gate array (FPGA), a programmable logic device (PLD), a controller, a microcontroller unit, a reduced instruction-set computer (RISC), a microprocessor, or the like, or any combination thereof.

The user device 120 may be configured to obtain input information from a user and transmit output information to the user. In some embodiments, the user device 120 may include a user interface connecting to a user device 120. In some other embodiments, the user device 120 may include an Application (APP) installed on the user device 120. The input information and the output information may exist in various forms including but not limited to speeches, texts, videos, pictures, etc. The input information may be provided via an input device of the user device 120 such as a microphone, a keyboard, a camera, a scanner, etc. The output information may be outputted through an output device of the user device 120 such as a speaker, a display, or the like, or any combination thereof. In some embodiments, the user device 120 may include a mobile phone 120-1, a tablet computer 120-2, a laptop computer 120-3, or the like, or any combination thereof.

A user may conduct a dialogue with the multi-task oriented dialogue system 100 via the user device 120. The dialogue may be a chat without any specific tasks, a task-oriented dialogue with one or more tasks to be performed (e.g., a taxi hailing task, a schedule inquiry task, a weather inquiry task, a ticket booking task), or a combination of them. In some embodiments, the one or more tasks may be performed by the user device 120. For example, the user may request a schedule inquiry in his or her user device 120 (e.g., a mobile phone). Then, after communicating with the server 110 or the processing engine 112, his or her mobile phone may respond to the request and output the user's schedule on the display of the user's mobile phone.

The external device 130 may be configured to perform one or more tasks received from the user. For example, the user, sitting in the office, may speak to his or her mobile phone “Help me turn on the air conditioner in my bedroom. I'll arrive home 20 minutes later.” The multi-task oriented dialogue system 100 may transmit a control signal to the air conditioner in his or her bedroom. The multi-task oriented dialogue system 100 may call an API relating to a controller (e.g., a central controlling system or a remote controller) of the air conditioner and the controller may turn on the air conditioner. The multi-task oriented dialogue system 100 may transmit a voice message to the mobile phone to inform the user that the air conditioner has been turned on.

In some embodiments, the external device 130 may include a built-in device in a motor vehicle 130-1, a smart home device 130-2, a monitoring device 130-3, or the like, or any combination thereof. In some embodiments, a built-in device in the motor vehicle 130-1 may include an onboard computer, an onboard television, etc. The smart home device 130-2 may include a smart lighting device, a control device of an intelligent electrical apparatus, a smart monitoring device, a smart television, a smart video camera, an interphone, or the like, or any combination thereof. The monitoring device 130-3 may include a monitor or a controller for monitoring/controlling an electronic equipment or a production process.

The network 140 may facilitate the exchange of information and/or data between the components of the multi-task oriented dialogue system 100. In some embodiments, one or more components in the multi-task oriented dialogue system 100 (e.g., the server 110, the user device 120, the external device 130, the storage 150) may transmit information and/or data to other component(s) in the multi-task oriented dialogue system 100 via the network 140. For example, the server 110 may obtain or acquire input information from the user device 120 via the network 140. In some embodiments, the network 140 may be any type of wired or wireless network, or a combination thereof. Merely by way of example, the network 140 may include a cable network, a wireline network, an optical fiber network, a telecommunications network, an intranet, the Internet, a local area network (LAN), a wide area network (WAN), a wireless local area network (WLAN), a metropolitan area network (MAN), a wide area network (WAN), a public telephone switched network (PSTN), a Bluetooth network, a ZigBee network, a near field communication (NFC) network, or the like, or any combination thereof.

The storage 150 may store data and/or instructions. In some embodiments, the storage 150 may store data obtained from the user device 120 and/or the external device 130. The storage 150 may store a dialogue corpus and a dialogue model. The storage 150 may store data and/or instructions that the server 110 may execute or use to perform methods described in the present disclosure. In some embodiments, storage 150 may include a mass storage, removable storage, a volatile read-and-write memory, a read-only memory (ROM), or the like, or any combination thereof. Exemplary mass storage may include a magnetic disk, an optical disk, a solid-state drive, etc. Exemplary removable storage may include a flash drive, a floppy disk, an optical disk, a memory card, a zip disk, a magnetic tape, etc. Exemplary volatile read-and-write memory may include a random-access memory (RAM). Exemplary RAM may include a dynamic RAM (DRAM), a double date rate synchronous dynamic RAM (DDR SDRAM), a static RAM (SRAM), a thyristor RAM (T-RAM), and a zero-capacitor RAM (Z-RAM), etc. Exemplary ROM may include a mask ROM (MROM), a programmable ROM (PROM), an erasable programmable ROM (EPROM), an electrically-erasable programmable ROM (EEPROM), a compact disk ROM (CD-ROM), and a digital versatile disk ROM, etc. In some embodiments, the storage 150 may be implemented on a cloud platform. Merely by way of example, the cloud platform may include a private cloud, a public cloud, a hybrid cloud, a community cloud, a distributed cloud, an inter-cloud, a multi-cloud, or the like, or any combination thereof.

In some embodiments, the storage 150 may be connected to the network 140 to communicate with one or more components in the multi-task oriented dialogue system 100 (e.g., the server 110, the user device 120, the external device 130). One or more components of the multi-task oriented dialogue system 100 may access the data or instructions stored in the storage 150 via the network 140. In some embodiments, the storage 150 may be directly connected to or communicate with one or more components in the multi-task oriented dialogue system 100 (e.g., the server 110, the user device 120, the external device 130). In some embodiments, the storage 150 may be part of the server 110.

In some embodiments, when a dialogue between a user and the multi-task oriented dialogue system 100 is to be conducted, one or more components in the multi-task oriented dialogue system 100 may exchange information with each other. The dialogue may include chatting without any specific tasks or performing one or more tasks in response to a user's one or more intentions or requests implied in the user's input information. In some embodiments, an object of a task may be tangible or intangible. The tangible object may include food, medicine, commodity, clothing, car, electronic product, electrical appliance, or the like, or any combination thereof. The intangible object may include entertainment service, reminder service, an Internet application, or the like, or any combination thereof. The Internet application may include a website, a mobile Internet application, or the like, or any combination thereof. The mobile Internet application may be used in a software of a mobile terminal, a program, a system, or the like, or any combination thereof. The mobile terminal may include a tablet computer, a laptop computer, a mobile phone, a personal digital assistance (PDA), a smart watch, a point of sale (POS) device, an onboard computer, an onboard television, a wearable device, or the like, or any combination thereof. For example, the object of the task may be any software and/or application used on the computer or mobile phone. The software and/or application may relate to socializing, shopping, transporting, entertainment, learning, investment, or the like, or any combination thereof.

It should be noted that the application scenario illustrated in FIG. 1 is only provided for illustration purposes and not intended to limit the scope of the present disclosure. For example, the multi-task oriented dialogue system 100 may be used as a remote speech control system. The remote speech control system may include a user terminal (e.g., the user device 120) and a controlled terminal (e.g., the external device 130). A user may input speech control information via the user terminal. The remote speech control system may accordingly transmit the control signal to the controlled terminal (e.g., a smart television) based on the process and/or method described in this disclosure and provide feedback information to the user terminal to be displayed or ask the user for more detailed information for further communication with the controlled terminal.

FIG. 2 is a schematic diagram illustrating exemplary hardware and software components of a computing device 200 on which the server 110, the user device 120, and/or the external device 130 may be implemented according to some embodiments of the present disclosure. For example, the processing engine 112 may be implemented on the computing device 200 and configured to perform functions of the processing engine 112 disclosed in this disclosure.

The computing device 200 may be a general-purpose computer or a special-purpose computer; both may be used to implement a multi-task oriented dialogue system for the present disclosure. The computing device 200 may be used to implement any component of the multi-task oriented dialogue system as described herein. For example, the processing engine 112 may be implemented on the computing device, via its hardware, software program, firmware, or a combination thereof. Although only one such computer is shown, for convenience, the computer functions relating to a dialogue, in particular, a multi-task oriented dialogue, as described herein may be implemented in a distributed fashion on a number of similar platforms, to distribute the processing load.

The computing device 200, for example, may include COM ports 250 connected to and/or from a network connected thereto to facilitate data communications. The computing device 200 may also include a processor 220, in the form of one or more processors, for executing program instructions. The exemplary computer platform may include an internal communication bus 210, program storage and data storage of different forms, for example, a disk 270, and a read only memory (ROM) 230, or a random access memory (RAM) 240, for various data files to be processed and/or transmitted by the computer. The exemplary computer platform may also include program instructions stored in the ROM 230, RAM 240, and/or another type of non-transitory storage medium to be executed by the processor 220. The method and/or process of the present disclosure may be implemented as the program instructions. The computer device 200 also includes an I/O component 260, supporting input/output between the computer and other components. The computing device 200 may also receive programming and data via network communications.

Merely for illustration, only one CPU and/or processor is described in the computing device 200. However, it should be noted that the computing device 200 in the present disclosure may also include multiple CPUs and/or processors, thus operations and/or method steps that are performed by one CPU and/or processor as described in the present disclosure may also be jointly or separately performed by the multiple CPUs and/or processors. For example, if in the present disclosure the CPU and/or processor of the computing device 200 executes both step A and step B, it should be understood that step A and step B may also be performed by two different CPUs and/or processors jointly or separately in the computing device 200 (e.g., the first processor executes step A and the second processor executes step B, or the first and second processors jointly execute steps A and B).

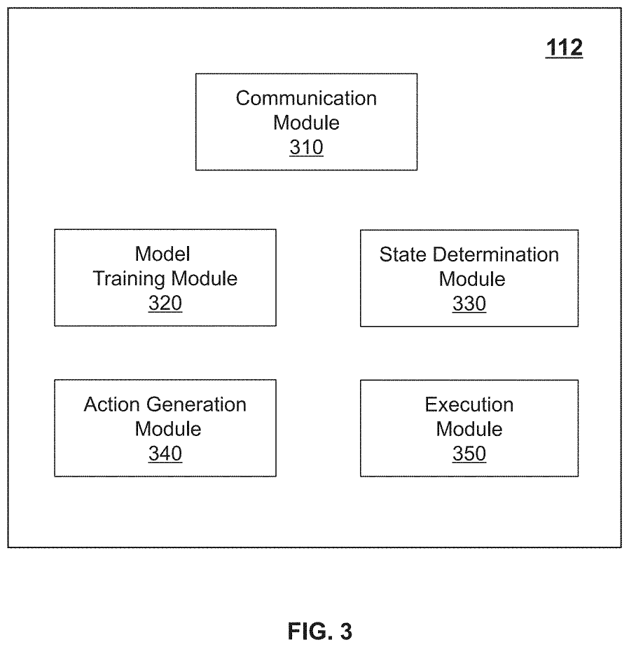

FIG. 3 is a block diagram illustrating an exemplary processing engine according to some embodiments of the present disclosure. The processing engine 112 may include a communication module 310, a model training module 320, a state determination module 330, an action generation module 340, and an execution module 350. Generally, the terms “module,” “unit,” and/or “engine” used herein, refers to logic embodied in hardware or firmware, or to a collection of software instructions. The modules, units, and engines described herein may be implemented as software and/or hardware modules and may be stored in any type of non-transitory computer-readable medium or other storage device. In some embodiments, a software module may be compiled and linked into an executable program. It will be appreciated that software modules can be callable from other modules or from themselves, and/or can be invoked in response to detected events or interrupts. Software modules configured for execution on computing devices (e.g., processor 220) can be provided on a computer readable medium, such as a compact disc, a digital video disc, a flash drive, a magnetic disc, or any other tangible medium, or as a digital download (and can be originally stored in a compressed or installable format that requires installation, decompression, or decryption prior to execution). Such software code can be stored, partially or fully, on a memory device of the executing computing device, for execution by the computing device. Software instructions can be embedded in a firmware, such as an EPROM. It will be further appreciated that hardware modules can be included of connected logic units, such as gates and flip-flops, and/or can be included of programmable units, such as programmable gate arrays or processors. The modules or computing device functionality described herein are preferably implemented as software modules, but can be represented in hardware or firmware. In general, the modules described herein refer to logical modules that can be combined with other modules or divided into sub-modules despite their physical organization or storage.

The communication module 310 may be configured to obtain input information and transmit output information. For example, the communication module 310 may be configured to obtain the input information from the user device 120 and transmit output information to the user device 120 via the network 140. The communication module 310 may include an I/O port and a user interface. The multi-task oriented dialogue system 100 may conduct a dialogue with a user when it receives input information from the user. In some embodiments, the dialogue may be a casual chat (e.g., an emotional communication) between the multi-task oriented dialogue system 100 and the user. Alternatively or additionally, the dialogue may be associated with one or more specific tasks that are required to finish in order to meet one or more intentions of the user such as a request for reminder service, ticket booking, etc. In some embodiment, the dialogue may include only one turn interaction between the multi-task oriented dialogue system 100 and the user. In some embodiment, the dialogue may include a plurality of interactions between the multi-task oriented dialogue system 100 and the user. As used herein, a turn of the interaction of a dialogue may refer to a situation that the user inputs information through the communication module 310 and the multi-task oriented dialogue system 100 outputs information, through the communication module 310, in response to the input information from the user. The user may input more information in a new turn of the dialogue or a new dialogue and the multi-task oriented dialogue system 100 may respond accordingly to generate a plurality of dialogues (or turns of dialogues).

In some embodiments, the input information may include simple words that express the user's emotions or feelings (e.g., “I am annoying,” “So tired”), and/or words containing or implying the user's one or more intentions or requests (e.g., “Book a flight to Beijing at 3:00 pm for my son and me,” “If it rains this afternoon, remind me to take an umbrella when I'm going out”). In some embodiments, the input information may be clear (e.g., “Please play Forrest Gump”), or vague (e.g., “I wanna listen to some happy music,” “Any good restaurants recommended”).

In some embodiments, the output information may include a reply to the user, or inform the user of a completion status of one or more tasks. For example, if the user says he or she is feeling bad, a sentence (e.g., “Oh, sorry to hear that, and would you mind sharing with me what happened?”) may be transmitted to the user. As another example, the user tells the multi-task oriented dialogue system 100 to book a flight to Shanghai at 8:00 a.m., the processing engine 112 or a component thereof (e.g., execution module 350) may access a flight-booking website to book a flight. However, the execution module 350 finds that all tickets at that time are sold out. The execution module 350 may generate output information to inform the user of the result and ask for more details about whether to change the departure time, the airline, or the like.

In some embodiments, the input information and the output information may exist in various forms including but not limited to speeches, texts, videos, pictures, etc. The input information may be provided by a user via an input device of the user device 120 such as a microphone, a keyboard, a camera, a scanner, etc. The output information may be outputted to the user through an output device of the user device 120 such as a speaker, a display, or the like, or any combination thereof.

The model training module 320 may be configured to train a dialogue model for generating one or more actions. The dialogue model may be an Artificial Neural Network (ANN) model such as a Convolutional Neural Network (CNN) model, a Recurrent Neural Network (RNN) model, etc. In some embodiments, the trained model may be transmitted to a storage device (e.g., the storage 150, a storage module (not shown) integrated into the processing engine 112) to be stored. The one or more actions may include a plurality of sentence-generating actions and/or a plurality of API-calling actions. The sentence-generating action may be configured to generate a sentence. The API-calling action may be configured to call an API. For example, the API may include an internal API that is used to communicate with other modules of the user device 120 to look up information in the user device 120 (e.g., looking up a schedule stored in the user device 120), an external API that is used to access data of external third party developers (e.g., accessing a ticket-booking website or a ticket-booking APP to book a ticket), etc.

The state determination module 330 may be configured to determine a dialogue state based on the input information obtained by the communication module 310. The state determination module 330 may determine the dialogue state based on at least one state of input information. The at least one state of input information may include a state of current input information and a state of historical input information. The at least one state of input information may be a tensor representing input information in a mathematical way. For example, a state of current input information may include one or more current intentions or requests (e.g., a request for reminder service, ticket booking service), detailed information of the one or more current intentions or requests (e.g., detailed information about booking a ticket such as time, locations, personal preferences), emotion of the user (e.g., happy, sad, nervous), or the like, or any combination thereof. As another example, a state of historical input information may include one or more historical intentions or requests of the user, detailed information of the one or more historical intentions or requests, historical emotion of the user, or the like, or any combination thereof. For example, the user's current intention is to “Book a flight to Shanghai on Saturday morning.” In a historical dialogue, the user told the multi-task oriented dialogue system 100 that “Remind me to attend a party at 19:00 this Saturday.” The dialogue state determined by the state determination module 330 may include not only information of booking a flight, but also information of reminding the party. The dialogue state including information of booking a flight and reminding the party may be further processed to determine whether there is a scheduling conflict between them. If there is a scheduling conflict, the multi-task oriented dialogue system 100 may cancel one of them. If there is no scheduling conflict, the multi-task oriented dialogue system 100 may perform both.

In some embodiments, the dialogue state may be changed or updated during the progress of the dialogue. The state determination module 330 may change or update the dialogue state under multiple situations, including but not limited to obtaining new input information from the user; executing an action, and receiving a feedback message from the external device 130 in response to a request (e.g., booking a flight; controlling a smart device).

In some embodiments; the state determination module 330 may be implemented by one or more Artificial Neural Network (ANN) models such as a Convolutional Neural Network (CNN) model, a Recurrent Neural Network (RNN) model; etc.

The action generation module 340 may be configured to generate one or more actions. The action generation module 340 may obtain a dialogue model pre-trained by the model training module 320 and generate one or more actions based on the dialogue model and the dialogue state determined by the state determination module 330.

The execution module 350 may be configured to execute the one or more actions generated by the action generation module 340. The one or more actions generated by the action generation module 340 may be abstract concepts and should be executed so that the user can understand. For a sentence-generating action, the execution module 350 may convert the sentence-generating action into a sentence under semantic and grammar rules that the user can understand. In some embodiments; the sentence-generating action may be converted to a question sentence for asking for more details from the user to complete a task. In some embodiments, the sentence-generating action may be converted to a confirmation sentence to inquire the user whether information of the task is right, or tell the user a completion status of the task. For an API-calling action, the execution module 350 may call a corresponding API to perform a specific task such as ordering, booking; shopping, etc. By calling the corresponding API, the execution module 350 may access an app or a website, or communicate with a smart device. In some embodiments, after an API-calling action is executed, a sentence-generating action may be further generated to indicate a completion status of a task. Then the sentence-generating action may be executed, e.g., be converted into a sentence under semantic and grammar rules that a user can understand.

In some embodiments, the one or more actions may be executed one by one after all the one or more actions are generated. In some embodiments, one of the plurality of actions may be generated based on the execution result of a previous action.

The modules in the processing engine 112 may be connected to and communicate with each other via a wired connection or a wireless connection. The wired connection may include a metal cable, an optical cable, a hybrid cable, or the like, or any combination thereof. The wireless connection may include a Local Area Network (LAN), a Wide Area Network (WAN), a Bluetooth, a ZigBee, a Near Field Communication (NFC), or the like, or any combination thereof. Two or more of the modules may be combined into a single module, and any one of the modules may be divided into two or more units. For example, the processing engine 112 may include a storage module (not shown in FIG. 3) which may be configured to store the input and/or output information, the trained dialogue model, the one or more actions, and/or any information associated with the dialogue.

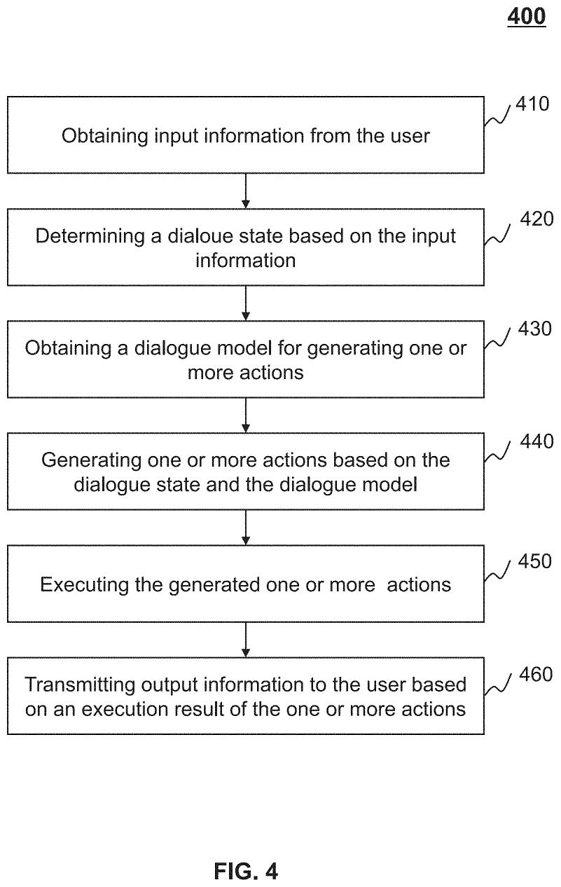

FIG. 4 is a flowchart of an exemplary process for conducting a dialogue according to some embodiments of the present disclosure. The process 400 may be executed by a component of the multi-task oriented dialogue system 100 (e.g. the server 110, the processing engine 112, the user device 120, the external device 130). In some embodiments, the process 600 may be implemented as a set of instructions (e.g., an application) stored in the storage ROM 230 or RAM 240. The processor 220 may execute the set of instructions and may be configured to cause the computing device 200 (e.g., the server 110, the user device 120, the external device 130) to perform the process 400.

In 410, communication module 310 may obtain input information from the user. The input information may include current input information and/or historical input information. In some embodiments, the input information may exist in various forms including but not limited to speeches, texts, videos, pictures, etc. The input information may be provided via an input device of the user device 120 such as a microphone, a keyboard, a camera, a scanner, etc. In some embodiments, the input information may include simple words that express the user's emotions or feelings (e.g., “I am annoying,” “So tired”), and/or words containing or implying the user's one or more intentions or requests (e.g., “Book a flight to Beijing at 3:00 p.m. for my son and me,” “If it rains this afternoon, remind me to take an umbrella when I'm going out”). In some embodiments, the input information may be clear (e.g., “Please play Forrest Gump”), or vague (e.g., “I wanna listen to some happy music,” “Any good restaurants recommended”).

By obtaining the input information form the user through the communication module 310, the multi-task oriented dialogue system 100 may start a dialogue with the user. In some embodiments, the multi-task oriented dialogue system 100 may start a dialogue with the user by transmitting any output information, indicating an intention of conducting a dialogue, to the user through the communication module 310. The dialogue may be a casual chat (e.g., an emotional communication) between the multi-task oriented dialogue system 100 and the user. In some embodiments, the dialogue may be associated with one or more specific tasks that the multi-task oriented dialogue system 100 is required to do in order to meet one or more intentions of the user such as a request for reminder service, ticket booking, etc. In some embodiment, the dialogue may include only one turn of interaction between the multi-task oriented dialogue system 100 and the user. In some embodiment, the dialogue may include a plurality of turns of interaction between the multi-task oriented dialogue system 100 and the user. As used herein, a turn of the interaction of a dialogue may refer to a situation that the user inputs information and the multi-task oriented dialogue system 100 outputs information in response to the input information from the user. The user may input more information in a new turn of the interaction of the dialogue or a new dialogue and the multi-task oriented dialogue system 100 may respond to generate a plurality of dialogues (or turns of dialogues). For example, in a dialogue, in turn 1, the user may input “If it rains, remind me to take an umbrella when I'm going out at 10.30 a.m.,” then the multi-task oriented dialogue system 100 may reply “Will remind you twice at 10:00 a.m. and 10:10 a.m. Shall I remind you one more time at 10:20 a.m.?”; in turn 2, the user may reply “One more time at 10:25 a.m.,” then the multi-task oriented dialogue system 100 may reply “OK, will remind you three times before you go out, and wish you a good day.”

In 420, the state determination module 330 may determine a dialogue state based on the input information. The state determination module 330 may determine the dialogue state based on at least one state of input information. The at least one state of input information may include a state of current input information and a state of historical input information. The at least one state of input information may be a tensor used to represent input information in a mathematical way. For example, a state of current input information may include one or more current intentions or requests (e.g., a request for reminder service, ticket booking service), detailed information on the one or more current intentions or requests (e.g., detailed information about booking a ticket such as time, locations, personal preferences), emotion of the user (e.g., happy, sad, nervous), or the like, or any combination thereof. As another example, a state of historical input information may include one or more historical intentions or requests of the user, detailed information of the one or more historical intentions or requests, the historical emotion of the user, or the like, or any combination thereof. For example, the user's current intention is to “Book a flight to Shanghai on Saturday morning.” However, in a historical dialogue, the user told the multi-task oriented dialogue system 100 that “Remind me to attend a party at 19:00 this Saturday.” Then the dialogue state determined in operation 420 may include not only information on booking a flight but also information of reminding the party. The dialogue state including information on booking a flight and reminding the party may be further processed to determine whether there is a scheduling conflict between them. If there is a scheduling conflict, the multi-task oriented dialogue system 100 may cancel one of them. If there is no scheduling conflict, the multi-task oriented dialogue system 100 may perform both.

In some embodiments, the dialogue state may be changed or updated during the progress of the dialogue. The state determination module 330 may change or update the dialogue state under multiple situations, including but not limited to obtaining new input information from the user, executing an action, and receiving a feedback message from the external device 130 in response to a request (e.g., booking a flight, controlling a smart device).

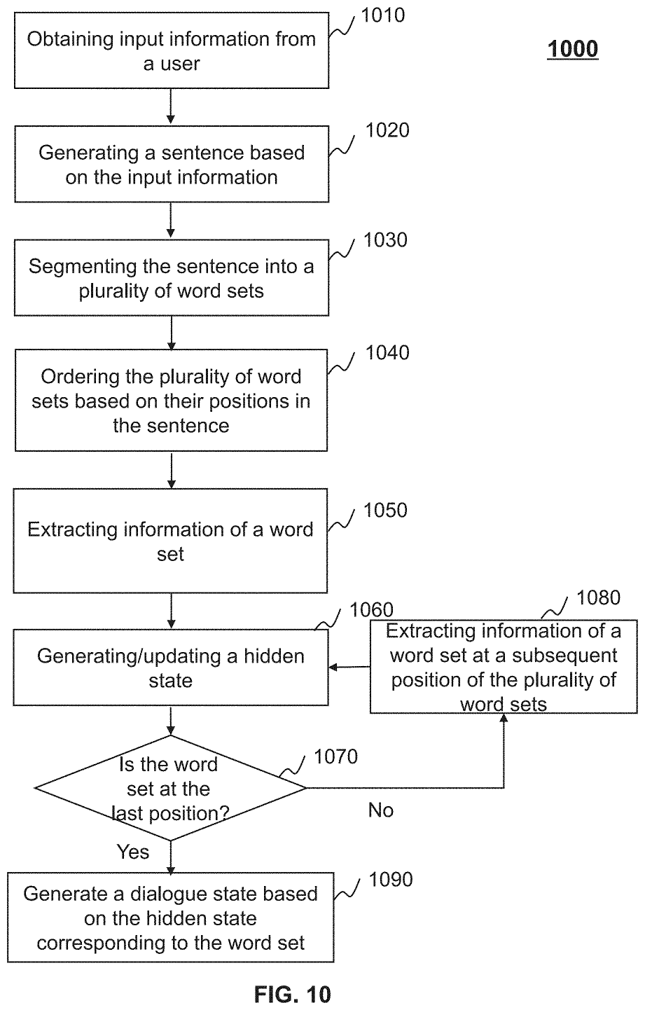

The detailed description regarding the determination of the dialogue state based on at least one state of input information may be found elsewhere in the present disclosure (e.g., FIG. 10 and the descriptions thereof).

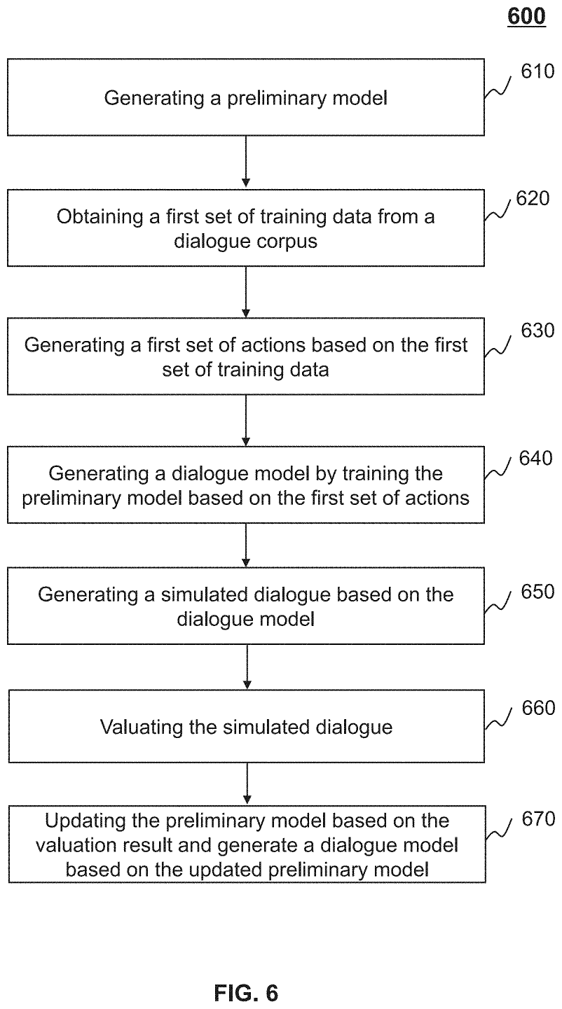

In 430, the action generation module 340 may obtain a dialogue model for generating one or more actions. The dialogue model may be pre-trained by the model training module 320. In some embodiments, the dialogue model may be updated based on one or more finished dialogues. The detailed description regarding the generation of the dialogue model may be found elsewhere in the present disclosure (e.g., FIG. 6 and the descriptions thereof).

In 440, the action generation module 340 may generate one or more actions based on the dialogue state and the dialogue model. The one or more actions may be configured in response to the input information to conduct a dialogue with the user and/or perform one or more tasks for the user. Each of the one or more actions may be of one of two types: a sentence-generating type and an API-calling type. The sentence-generating action may be configured to generate a sentence. For example, if the user's input information is “Hi,” the action generation module 340 may run the dialogue model to generate a sentence-generating action corresponding to a sentence such as “Hi, what can I do for you,” to answer the user and ask for more information.

In some embodiments, the API-calling action may be configured to call an API to perform a task. For example, the state determination module 330 may determine that the input information from the user may contain or imply more than one intention or request, which relate to more than one task to be performed. Accordingly, in operation 440, the action generation module 340 may generate an action corresponding to each of the more than one task. For example, the state determination module 330 may determine that the input information “If it rains, remind me to take an umbrella when I am going out” may contain or imply three intentions of the user: a schedule inquiry, a weather inquiry and a reminder of taking an umbrella. The action generation module 340 may run the dialogue model to generate three API-calling actions (e.g., action 1, action 2, and action 3A respectively shown in Table 1). The three API-calling actions may be further executed in operation 450 to perform three corresponding tasks.

TABLE 1

| | |
|---|---|
| Turn 1: | “If it rains, remind me to take an umbrella |
| Input | when I'm going out.” |
| information | |
| from the user | |
| Action 1 | An API-calling action for calling an API to look |
| | up the user's schedule to obtain the time |
| | when the user plans to go out. |
| Execution result | Find out that the user has a party at 11:00 a.m. |
| of action 1 | today. |
| Action 2 | An API-calling action for calling an API to check |
| | the weather at about 11:00 a.m. |
| Execution result | A: It rains during 10:00 a.m. and 12:00 a.m. |
| of action 2 | B: It's sunny today. |
| Action 3 | A: An API-calling action for calling an API to |
| | remind the user to take an umbrella before |
| | 10:30 a.m. |
| | B: A sentence-generating action for generating |
| | a sentence to tell the user it's a good day |
| | today. |
| Execution result | A: Record the event of reminding the user to |
| of action 3 | take an umbrella at 10:00 a.m. and 10:10 a.m. |
| | respectively. |
| | B: Generate a sentence to tell the user it's |
| | a good day today. |
| Turn 1: | A: “Will remind you twice at 10:00 a.m. and |
| Output information | 10:10 a.m. Shall I remind you one more time at |
| from the system | 10:20 a.m.?” |
| | B: “It's a great sunny day, you don't |
| | need to take an umbrella when you go out.” |
| Turn 2: | A: “One more time at 10:25 a.m.” |
| Input information | B: “OK” or no more input information |
| from the user | from the user. |
| Turn 2: | A: “OK, will remind you three times before |
| Output information | you go out, and wish you a wonderful party |
| from the system | today.” |
| | B: “Wish you a wonderful party today.” |

In some embodiments, both sentence-generating actions and API-calling actions may be generated in each turn of a dialogue. For example, in turn 1 of the dialogue shown in Table 1, two API-calling actions (i.e., action 1 and action 2) and a sentence-generating (i.e., action 3B) are generated.

The one or more actions each may include a name and one or more slot-pairs for generating a sentence or calling an API. Alternatively, some of the one or more actions may each include a name but no slot-pair. A slot-pair may include a slot and a slot value. For example, for a sentence-generating action, the name of the sentence-generating action may be “express thanks”; the slot may be “degree of gratitude,” and the slot value may be “deeply.” As another example, for an API-calling action, the name of the API-calling action may be “ticket booking”; slot 1 is “departure city,” the value of slot 1 may be “Beijing”; slot 2 may be destination city,” the value of slot 2 may be “Shanghai”; slot 3 may be “departure time,” the value of slot 3 may be “12 a.m. on May 15.” In some embodiments, a slot value may be empty at the beginning of the dialogue and may be filled gradually during the progress of the dialogue. In some embodiments, some of the slot values may be filled by some common information based on one or more historical dialogues at the beginning of the dialogue. In some embodiments, the slot values may be changed by the action generation module 340 during the progress of the dialogue.

In 450, the execution module 350 may execute the generated one or more actions. For a sentence-generating action, the execution module 350 may convert the sentence-generating action into a sentence with semantic and grammar rules that the user can understand. In some embodiments, the sentence-generating action may be converted to a question for asking for more details from the user to complete a task. For example, for the dialogue in Table 2, the sentence provided by the multi-task oriented dialogue system 100 in turn 1 is a question for asking a more accurate departure time to complete the flight booking task. In some embodiments, the sentence-generating action may be converted to a confirmation sentence to ask the user whether information of the task is correct or tell the user a completion status of the task. For example, for the dialogue in Table 2, the sentences of the multi-task oriented dialogue system 100 in turn 2 and 3 are confirmation sentences to ask the user whether information of the flight booking task is correct and tell the user that the flight task has been completed respectively,

TABLE 2
A dialogue for booking a flight ticket

| Turn | User/System | Input or output information |
|---|---|---|
| Turn 1 | User | Book a flight from Shanghai to |
| | | Beijing at 3:00 p.m. for me. |
| | System | Which airline do you want? |
| Turn 2 | User | China Eastern. |
| | System | Will book a China Eastern flight |
| | | from Shanghai to Beijing at 3:00 |
| | | p.m. today for you. |
| Turn 3 | User | OK. |
| | System | Have successfully booked a flight |
| | | from Shanghai to Beijing at 3:00 |
| | | p.m. today. The flight number is |
| | | AB1234, and the airline is China |
| | | Eastern. |

For an API-calling action, the execution module 350 may call an API to perform a specific task such as ordering, booking, shopping, etc. By calling the API, the execution module 350 may access an app or a website, or communicate with a device. For example, for the dialogue in Table 1, the action 1 may be executed to search the user's schedule (via, for example, the user's smartphone or a web service like Google Calendar), and the action 2 may be executed to access a weather-forecast database (via, for example, a weather-forecast app or a weather-forecast website) to check the weather. As another example, in Table 3, action 1 and action 3 may be executed to control the air conditioner locally or remotely. In some embodiments, after an API-calling action is executed, a sentence-generating action may be further generated to indicate a completion status of a task. Then the sentence-generating action may be executed, e.g., be converted into a sentence with semantic and grammar rules that a user can understand. For example, in Table 3, after action 1 is executed, action 2 may be generated and converted into a sentence “It has been turned on. What temperature do you prefer” to ask the user for more information.

TABLE 3
A dialogue for controlling a smart home

| | |
|---|---|
| Turn 1: | “Help me turn on the air conditioner.” |
| Input information | |
| from the user | |
| Action 1 | An API-calling action for calling an API |
| | to turn on the air conditioner. |
| Execution result | The air conditioner has been turned on. |
| of action 1 | |
| Action 2 | A sentence-generating action for generating |
| | a sentence to ask the user what temperature |
| | the air conditioner should be adjusted to. |
| Execution result | Generate a sentence “What temperature do |
| of action 2 | you prefer” to the user. |
| Turn 1: | “It has been turned on. What temperature |
| Output information | do you prefer?” |
| from the system | |
| Turn 2: | “26° C.” |
| Input information | |
| from the user | |
| Action 3 | An API-calling action for calling an API |
| | to set the temperature to 26° C. |
| Execution result | The temperature is set to 26° C. |
| of action 3 | |
| Action 4 | A sentence-generating action for generating |
| | a sentence to tell the user the task has |
| | been completed. |
| Execution result | Generate a sentence “The temperature has |
| of action 4 | been set to 26° C. Anything else I can |
| | help you” to tell the user. |
| Turn 2: | “The temperature has been set to 26° C. |
| Output information | Anything else I can help you?” |
| from the system | |

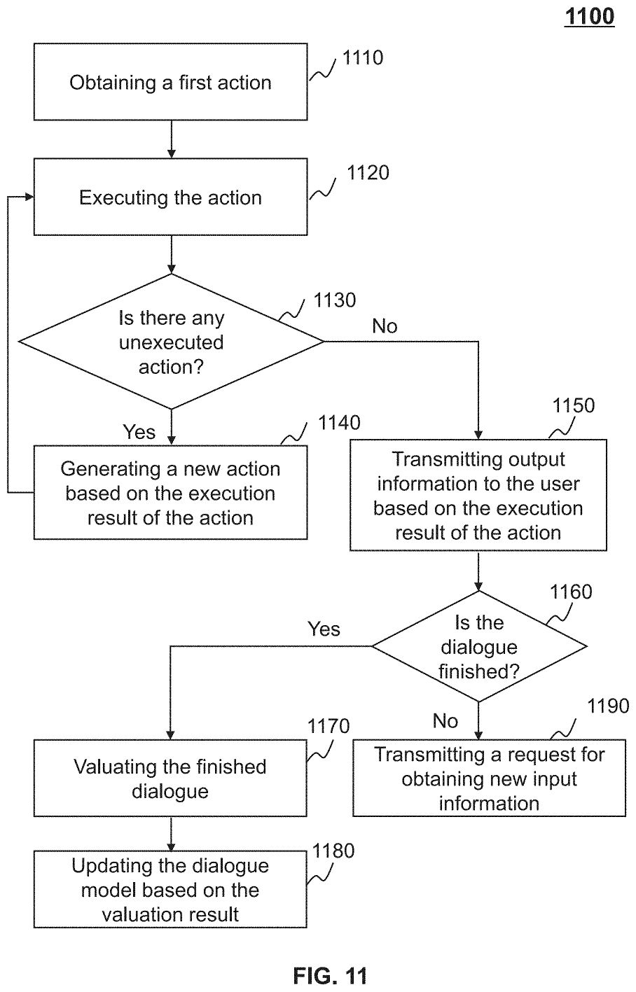

In some embodiments, the one or more actions may be executed one by one after all the one or more actions are generated. For example, in Table 3, after both action 1 and action 2 are generated, action 1 and action 2 may be executed one by one. In some embodiments, one of the one or more actions may be generated based on the execution result of a previous action. For example, in Table 1, the execution module 540 may first execute action 1 to find out that the user has a party at 11:00 a.m. today and generate action 2 to check the weather at 11:00 a.m. The detailed description regarding the execution of the one or more actions may be found elsewhere in the present disclosure (e.g., FIG. 11 and the descriptions thereof).

In some embodiments, the one or more actions may include an action for releasing a turn (also referred to as the release turn action). The release turn action may indicate either the user or the multi-task oriented dialogue system has finished the party's action(s) in a turn of the dialogue. For example, the release turn action may be generated by the multi-task oriented dialogue system 100 when the user has finished inputting information or the user replies nothing to the multi-task oriented dialogue system 100 for a preset period. For example, after the user inputs “Help me turn on the air conditioner” (as illustrated in Table 3), the multi-task oriented dialogue system 100 may consider that the user has finished inputting information and generate a release turn action accordingly. As another example, after action 1 and 2 (illustrated in Table 3) are executed, a release turn action may be generated as the multi-task oriented dialogue system 100 has executed all actions in turn 1. As yet another example, the release turn action may be generated when the multi-task oriented dialogue system 100 has executed all sentence-generating actions and API-calling actions in its turn of dialogue. In some embodiments, if two successive release turn actions are generated in a turn of a dialogue (e.g., indicating both the user and the multi-task oriented dialogue system have finished their actions), the multi-task oriented dialogue system may determine that the dialogue may end and may terminate the dialogue.

In 460, the communication module 310 may transmit output information to the user based on an execution result of the one or more actions. The output information may be one or more sentences generated according to one or more sentence-generating actions. The output information may be used to reply the user or inform the user of a completion status of one or more tasks. The output information may be shown to the user in various forms including but not limited to speeches, texts, videos, pictures, etc. For example, the output information may be shown on the user device 120 in text form. As another example, the output information may be transformed into speech from the text by text-to-speech technologies.

It should be noted that, if the dialogue state determined in operation 420 includes information of emotion of the user, the multi-task oriented dialogue system 100 may take the emotion of the user into consideration when replying the user. For example, for a similar task of reminder of taking an umbrella shown in Table 1, if the user is in a good mood, the multi-task oriented dialogue system 100 may reply “I know you're excited, but please don't forget your umbrella” at 10:20 a.m.; if the user is sad, the multi-task oriented dialogue system 100 may reply “Cheer up! You are going out for a party, and it's a good way to relax. Please remember to take an umbrella with you” at 10:20 a.m.

It should be noted that the above description is merely provided for the purposes of illustration, and not intended to limit the scope of the present disclosure. For persons having ordinary skills in the art, multiple variations and modifications may be made under the teachings of the present disclosure. However, those variations and modifications do not depart from the scope of the present disclosure. For example, the process 400 may include further steps such as determining whether the dialogue is finished or obtaining new information from the user after operation 460.

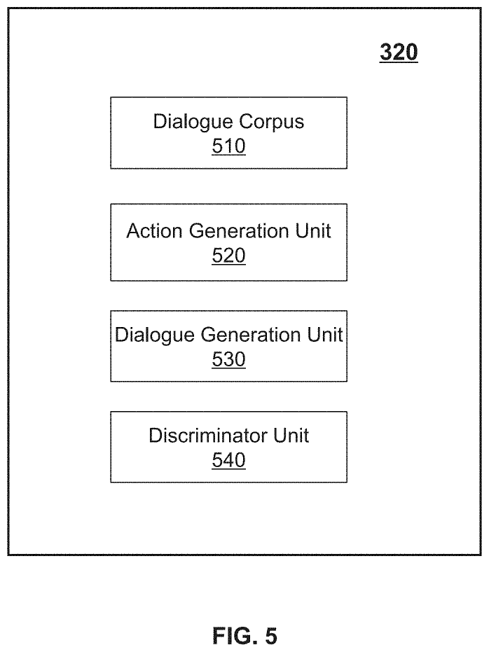

FIG. 5 is a block diagram illustrating an exemplary dialogue model training module according to some embodiments of the present disclosure. The model training module 320 may include a dialogue corpus 510, a sample action generation unit 520, a dialogue generation unit 530, and a discriminator unit 540.

The dialogue corpus 510 may be configured to store a plurality of human dialogues and APIs. The human dialogue may include a dialogue between human beings, a dialogue involving at least one human being, or at least part of a dialogue that involves at least one human being. For example, the dialogue corpus may include human dialogues collected from various resources, including, for example, the Internet such as blogs, social networks, novels, etc. As another example, the dialogue corpus may include human dialogues collected from an offline database. In some embodiments, the dialogue corpus may be a monolingual corpus (e.g. a Chinese corpus, or an English corpus) or a multilingual corpus (e.g. a Chinese-English corpus, a Chinese-English-French corpus). The dialogue corpus may be online or offline. The plurality of human dialogues and APIs may serve as training data for training a model dialogue.

The sample action generation unit 520 may be configured to generate a plurality sets of sample actions. The sample action generation unit 520 may extract a plurality sets of training data from the dialogue corpus 510 and generate the plurality sets of sample actions based on the plurality sets of training data.

The dialogue generation unit 530 may be configured to generate a dialogue model by training a preliminary model based on the plurality sets of sample actions. The preliminary model may be an Artificial Neural Network (ANN) model such as a Convolutional Neural Network (CNN) model, a Recurrent Neural Network (RNN) model, etc. The preliminary model may include a plurality of default parameters. The dialogue generation unit 530 may update the plurality of default parameters based on the plurality sets of sample actions and train the dialogue model.

In some embodiments, the dialogue generation unit 530 may generate a plurality of simulated dialogues based on the dialogue model. The dialogue generation unit 530 may obtain a human dialogue between two people. Half of the dialogue (e.g., sentences generated by one person) may be deleted and the dialogue generation unit 530 may complete the dialogue based on the dialogue model to generate a simulated dialogue. In some embodiments, the dialogue generation unit 530 may execute the dialogue model twice or execute two dialogue models simultaneously. The two dialogue models may simulate two people talking with each other, and a simulated dialogue may be generated.

The discriminator unit 540 may be configured to valuate a dialogue. The dialogue may be a simulated dialogue generated by the dialogue generation unit 530 when training the dialogue model. The discriminator unit 540 may valuate the dialogue by calculating the dialogue's probability of being a human dialogue. For example, for a human dialogue obtained from a dialogue corpus 510, the probability may be 1. As another example, for a simulated dialogue generated by the dialogue generation unit (e.g., the simulated dialogue generated by completing the half of deleted dialogue), the probability may be 0.5, 0.8, etc. The discriminator unit 540 may generate a valuation result based on the valuation and transmit the valuation result to the dialogue generation unit 530. The dialogue generation unit 530 may update the dialogue model based on the valuation result. The process of updating the dialogue model based on a valuation result may be implemented by using a Reinforcement Learning (RL) algorithm. The RL algorithm may include Dynamic Programming (DP), Temporal Differences (TD), Q-Learning, etc.

In some embodiments, the discriminator unit 540 may be implemented by a value model. The value model may be an Artificial Neural Network (ANN) model such as a Convolutional Neural Network (CNN) model, a Recurrent Neural Network (RNN) model, etc. A target (e.g., a target function) of the value model may include making a probability distribution of simulated dialogues generated by the dialogue model similar to or same as a probability distribution of human dialogues (e.g., human dialogues in the dialogue corpus 510). The dialogue model and the value model may be combined into a Generative Adversarial Network (GAN) model. The model training module 320 may perform alternate training on the dialogue model and the value model to generate (and/or train) the GAN model.

FIG. 6 is a flowchart illustrating an exemplary process for generating a dialogue model according to some embodiments of the present disclosure. In some embodiments, the dialogue model obtained in operation 430 of the process 400 may be generated according to the process 600. The process 600 may be executed by a component of the multi-task oriented dialogue system 100 (e.g. the server 110, the processing engine 112, the user device 120, the external device 130). In some embodiments, the process 600 may be implemented as a set of instructions (e.g., an application) stored in the storage ROM 230 or RAM 240. The processor 220 may execute the set of instructions and may be configured to cause the computing device 200 (e.g., the server 110, the user device 120, the external device 130) to perform the process 600.

In 610, the dialogue model generation unit 530 may obtain a preliminary model. The preliminary model may be an untrained Artificial Neural Network (ANN) model such as a Convolutional Neural Network (CNN) model, a Recurrent Neural Network (RNN) model, etc.

In 620, the sample action generation unit 520 may obtain the first set of training data from a dialogue corpus. In some embodiments, the dialogue corpus may include a plurality of human dialogues and APIs. The human dialogue may include a dialogue between human beings, a dialogue involving at least one human being, or at least part of a dialogue that involves at least one human being. For example, the dialogue corpus may include human dialogues collected from various resources, including, for example, the Internet such as blogs, social networks, novels, etc. As another example, the dialogue corpus may include human dialogues collected from an offline database. In some embodiments, the dialogue corpus may be a monolingual corpus (e.g. a Chinese corpus, or an English corpus) or a multilingual corpus (e.g. a Chinese-English corpus, a Chinese-English-French corpus). The dialogue corpus may be online or offline. In some embodiments, the first set of training data may be associated with a first dialogue in the dialogue corpus. The first dialogue may include an interaction in a dialogue between two humans. The first dialogue may exist in various forms such as speech information, text information, video information, picture information, or the like, or any combination thereof. In some embodiments, the first dialogue may also include APIs called in the first dialogue. For example, in a case that a first person asks a second person about the weather, and the second person searches a website for the weather. The dialogue stored in the multi-task oriented dialogue system 100 relating to this case may include the dialogue between the two persons and the APIs related to the website (e.g., a browser, a URI). In some embodiments, the first dialogue may be obtained directly from a social network (e.g., the network 140), or be inputted manually. The first set of training data may be labeled or unlabeled.

In 630, the sample action generation unit 520 may generate a first set of actions based on the first set of training data. The first set of sample actions may include performing one or more tasks. In some embodiments, the first set of sample actions may include one or more sentence-generating actions and/or one or more API-calling actions. The sentence-generating action may be configured to generate a sentence. The API-calling action may be configured to call an API. For example, the API may include an internal API that is used to communicate with other modules of the user device 120 to look up information in the user device 120 (e.g., looking up a schedule stored in the user device 120). Alternatively or additionally, the API may include an external API that is used to access data of external third party developers (e.g., accessing a ticket-booking website or a ticket-booking APP to book a ticket).

In 640, the dialogue model generation unit 530 may generate a dialogue model by training the preliminary model based on the first set of sample actions. The preliminary model may include a plurality of default parameters. The dialogue generation unit 530 may update the plurality of default parameters based on the first set of sample actions.

In 650, dialogue generation unit 530 may generate a simulated dialogue based on the dialogue model. In some embodiments, the dialogue generation unit 530 may obtain a human dialogue between two people. Half of the dialogue (e.g., sentences generated by one person) may be deleted and the dialogue generation unit 530 may complete the dialogue based on the dialogue model to generate a simulated dialogue. In some embodiments, the dialogue generation unit 530 may execute the dialogue model twice or execute two dialogue models simultaneously. The two dialogue models may simulate two people talking with each other, and a simulated dialogue may be generated.

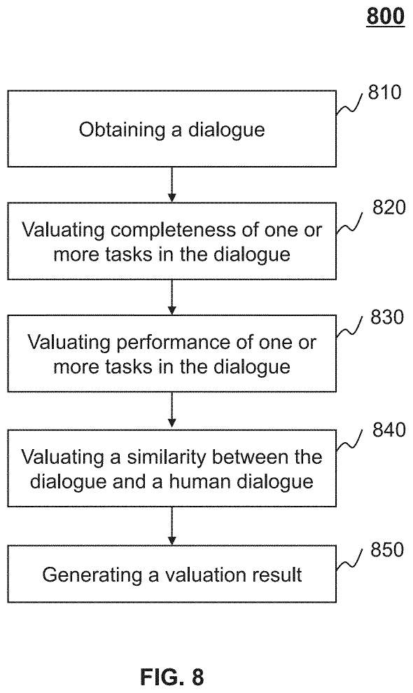

In 660, the discriminator unit 540 may valuate the simulated dialogue. The discriminator unit 540 may valuate the simulated dialogue by calculating the simulated dialogue's probability of being a human dialogue. For example, if the simulated dialogue is generated by completing the half of the deleted dialogue as illustrated in operation 650, the discriminator unit 540 may calculate a probability (e.g., 0.5, 0.8) for the simulated dialogue. The discriminator unit 540 may generate a valuation result based on the valuation and may transmit the valuation result to the dialogue generation unit 530. The valuation may be implemented by a value model. The value model may be an Artificial Neural Network (ANN) model such as a Convolutional Neural Network (CNN) model, a Recurrent Neural Network (RNN) model, etc. The detailed description regarding the valuation of the simulated dialogue may be found elsewhere in the present disclosure (e.g., FIG. 8 and the descriptions thereof).

In some embodiments, a target (e.g., a target function) of the value model may include making a probability distribution of simulated dialogues generated by the dialogue model similar to or same as a probability distribution of human dialogues (e.g., human dialogues in the dialogue corpus 510). The dialogue model and the value model may be combined as a Generative Adversarial Network (GAN) model. The model training module 320 may perform alternate training on the dialogue model and the value model to generate the GAN model.

In 670, the dialogue generation unit 530 may update the dialogue model based on the valuation result. The process of updating the dialogue model based on a valuation result may be implemented by using a Reinforcement Learning (RL) algorithm. The RL algorithm may include Dynamic Programming (DP), Temporal Differences (TD), Q-Learning, etc.

It should be noted that the process 600 may be performed repeatedly. For example, the second set of training data associated with a second dialogue (and further sets of training data associated with further dialogues) may be further obtained in operation 610 and operations 620-670 may repeatedly be performed to train and/or update the dialogue model.

In some embodiments, after the training of the dialogue model is finished, the dialogue model may be configured to generate one or more appropriate actions in response to input information from a user. Further, the discriminator unit 540 may valuate finished dialogues between the user and the multi-task oriented dialogue system 100 and update the dialogue model based on valuation results.

It should be noted that the above description is merely provided for the purposes of illustration, and not intended to limit the scope of the present disclosure. For persons having ordinary skills in the art, multiple variations and modifications may be made under the teachings of the present disclosure. However, those variations and modifications do not depart from the scope of the present disclosure. For example, the process 600 may include steps of training a value model. As another example, the training of the dialogue model and the value model may be alternately performed, and the trained dialogue model and value model may be combined into a GAN model.

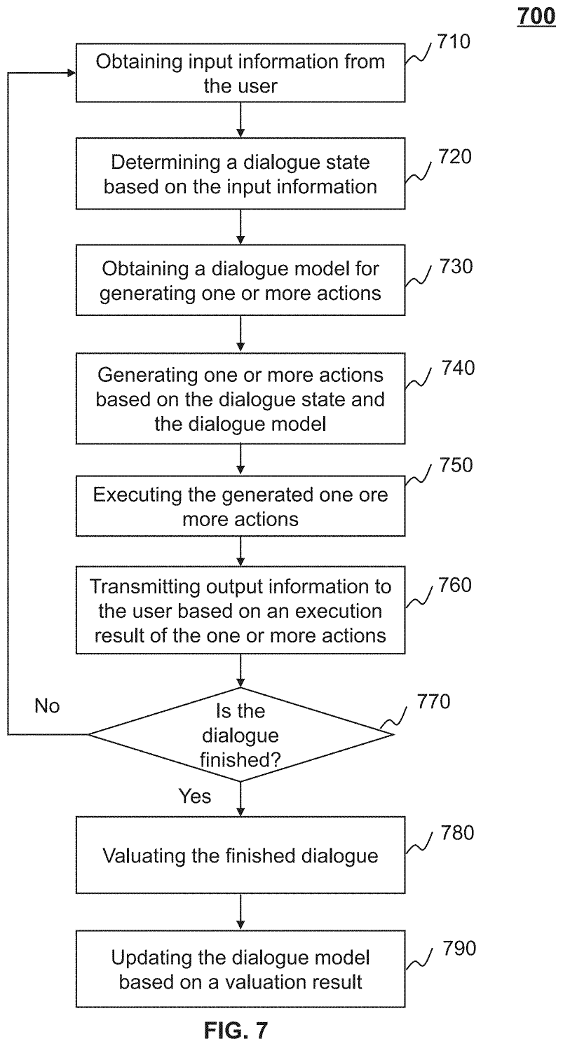

FIG. 7 is a flowchart of an exemplary process for conducting a dialogue according to some embodiments of the present disclosure. The process 700 may be executed by a component of the multi-task oriented dialogue system 100 (e.g. the server 110, the processing engine 112, the user device 120, the external device 130). In some embodiments, the process 700 may be implemented as a set of instructions (e.g., an application) stored in the storage ROM 230 or RAM 240. The processor 220 may execute the set of instructions and may be configured to cause the computing device 200 (e.g., the server 110, the user device 120, the external device 130) to perform the process 700.

In 710, the communication module 310 may obtain input information from the user. The input information may exist in various forms including but not limited to speeches, texts, videos, pictures, etc. The input information may be provided via an input device of the user device 120 such as a microphone, a keyboard, a camera, a scanner, etc. Operation 710 may be similar to operation 410 of the process 400 described elsewhere in this application and the description of operation 710 is not repeated herein.

In 720, the state determination module 330 may determine a dialogue state based on the input information. Operation 720 may be similar to operation 420 of the process 400 described elsewhere in this application and the description of operation 720 is not repeated herein.

In 730, the action generation module 340 may obtain a dialogue model for generating one or more actions. Operation 730 may be similar to operation 430 of the process 400 described elsewhere in this application and the description of operation 730 is not repeated herein.

In 740, the action generation module 340 may generate one or more actions based on the dialogue state and the dialogue model. Operation 740 may be similar to operation 440 of the process 400 described elsewhere in this application and the description of operation 740 is not repeated herein.

In 750, the execution module 350 may execute the one or more actions. Operation 750 may be similar to operation 450 of the process 400 described elsewhere in this application and the description of operation 750 is not repeated herein.

In 760, the communication module 310 may transmit output information to the user based on an execution result of the one or more actions. Operation 760 may be similar to operation 460 of the process 400 described elsewhere in this application and the description of operation 760 is not repeated herein.

In 770, the execution module 350 may determine whether the dialogue is finished. In some embodiments, the one or more actions may include an action for releasing a turn (also referred to as the release turn action). The release turn action may indicate either the user or the multi-task oriented dialogue system has finished the party's action(s) in a turn of the dialogue. For example, the release turn action may be generated by the multi-task oriented dialogue system 100 when the user has finished inputting information or the user replies nothing to the multi-task oriented dialogue system 100 for a preset period. As another example, the release turn action may be generated when the multi-task oriented dialogue system 100 has executed all sentence-generating actions and API-calling actions in its turn of dialogue. In some embodiments, if two successive release turn actions are generated in a turn of a dialogue (e.g., indicating both the user and the multi-task oriented dialogue system 100 have finished their actions), the execution module 350 may determine that the dialogue may end and may terminate the dialogue.

In response to the determination that the dialogue is unfinished, the process 700 may proceed back to 710, and the communication module 310 may obtain new input information from the user.

In response to the determination that the dialogue is finished, the process 700 may proceed to 780. In 780, the discriminator unit 540 may valuate the finished dialogue. The finished dialogue may include all data generated during the whole dialogue such as the input information, dialogue states, one or more actions in response to the input information, execution results of the one or more actions, etc. The finished dialogue may be transmitted to the storage 150 via network 140. After the dialogue is finished, the discriminator unit 540 may valuate the finished dialogue based on criteria such as the completeness of one or more tasks, the performance of one or more tasks, the probability of the finished dialogue being a human dialogue, or the like, or any combination thereof. The detailed description regarding the valuation of the finished dialogue may be found elsewhere in the present disclosure (e.g., FIG. 8 and the descriptions thereof).

In 790, the model training module 320 may update the dialogue model based on a valuation result. The process of updating the dialogue generation model based on the valuation result may be implemented by using a Reinforcement Learning (RL) algorithm. The RL algorithm may include Dynamic Programming (DP), Temporal Differences (TD), Q-Learning, etc.

It should be noted that, if the dialogue state determined in operation 730 includes information of emotion of the user, the multi-task oriented dialogue system 100 may take the emotion of the user into consideration when replying the user. For example, for a similar task of reminder of taking an umbrella shown in Table 1, if the user is in a good mood, the multi-task oriented dialogue system 100 may reply “I know you're excited, but please don't forget your umbrella” at 10:20 a.m.; if the user is sad, the multi-task oriented dialogue system 100 may reply “Cheer up! You are going out for a party, and it's a good way to relax. Please remember to take an umbrella with you” at 10:20 a.m.

FIG. 8 is a flowchart of an exemplary process for valuating a dialogue according to some embodiments of the present disclosure. The process 800 may be executed by a component of the multi-task oriented dialogue system 100 (e.g. the server 110, the processing engine 112, the user device 120, the external device 130). In some embodiments, the process 600 may be implemented as a set of instructions (e.g., an application) stored in the storage ROM 230 or RAM 240. The processor 220 may execute the set of instructions and may be configured to cause the computing device 200 (e.g., the server 110, the user device 120, the external device 130) to perform the process 800.

In 810, the discriminator unit 540 may obtain a dialogue. In some embodiments, the dialogue may be a simulated dialogue generated when training a dialogue model (e.g., as illustrated in operation 650). In some embodiments, the dialogue may be a finished dialogue between a user and the multi-task oriented dialogue system 100 (e.g., as illustrated in operation 780 and/or 1170).

In 820, the discriminator unit 540 may valuate the completeness of one or more tasks in the dialogue (also referred to as a first valuation). For example, the discriminator unit 540 may determine whether the one or more tasks have been completed, such as whether a flight has been successful booked, whether a smart device has been turned on in response to the user's request, etc. In some embodiments, the completeness of one or more tasks may be valuated by the user that conducts the dialogue with the multi-task oriented dialogue system 100, or a third-party service provider that is related to the multi-task oriented dialogue system 100 or the external device 130.

In 830, the discriminator unit 540 may valuate the performance of one or more tasks in the dialogue (also referred to as a second valuation). For example, after the dialogue is finished, the communication module 310 may output one or more questions to the user, such as “Are you satisfied with the song I played for you?”, “Are you feeling better after talking with me?” etc. The discriminator unit 540 may generate a valuation result based on the user's response.

In 840, the discriminator unit 540 may valuate the dialogue by calculating the dialogue's probability of being a human dialogue. For example, for a human dialogue obtained from the dialogue corpus 510, the probability may be 1. As another example, for a simulated dialogue generated by multi-task oriented dialogue system 100, the probability may be 0.5, 0.8, etc. As a further example, for a finished dialogue between a user and the multi-task oriented dialogue system 100, the probability may be 0.7, 0.9, etc. The human dialogue is a real dialogue between two humans. In some embodiments, the human dialogue may be stored in a dialogue corpus. In some embodiments, the human dialogue may be obtained directly from a social network, or be inputted manually.

In 850, the discriminator unit 540 may generate a valuation result. The discriminator unit 540 may generate the valuation result based on the valuation on the completeness of one or more tasks in the dialogue, the performance of one or more tasks, the probability of the dialogue being a human dialogue, or the like, or any combination thereof. In some embodiments, the valuation result may be used to update the dialogue model.

In some embodiments, the valuation may be implemented by a value model. The value model may be an Artificial Neural Network (ANN) model such as a Convolutional Neural Network (CNN) model, a Recurrent Neural Network (RNN) model, etc. In some embodiments, a target (e.g., a target function) of the value model may include making a probability distribution of simulated dialogues generated by the dialogue model similar to or same as a probability distribution of human dialogues (e.g., human dialogues in the dialogue corpus 510). The dialogue model and the value model may be combined as a Generative Adversarial Network (GAN) model. The model training module 320 may perform alternate training on the dialogue model and the value model to generate the GAN model.

The valuating processes in operation 660, operation 780 and/or operation 1170 may be performed according to the process 800.

It should be noted that the above description is merely provided for the purposes of illustration, and not intended to limit the scope of the present disclosure. For example, the valuation criterions may not be limited to those described above (e.g., the completeness of one or more tasks in the dialogue, the performance of one or more tasks, the probability of the dialogue being a human dialogue). As another example, operations 820, 830, and 840 can be implemented simultaneously or in any order. For persons having ordinary skills in the art, multiple variations and modifications may be made under the teachings of the present disclosure. However, those variations and modifications do not depart from the scope of the present disclosure.

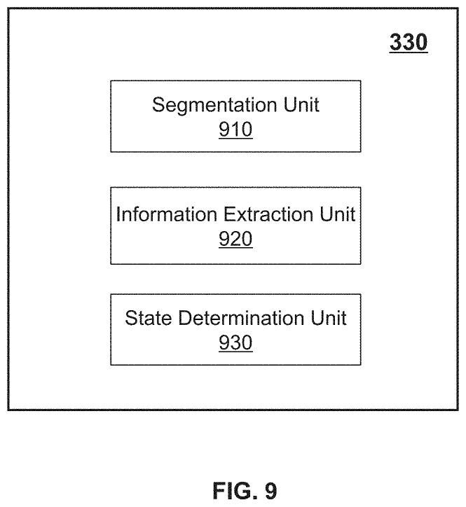

FIG. 9 is a block diagram of an exemplary state determination module according to some embodiments of the present disclosure. The state determination module 330 may include a segmentation unit 910, an information extraction unit 920 and a state determination unit 930.

The segmentation unit 910 may be configured to segment a sentence into a plurality of tokens (or word sets). The sentence may be generated by the segmentation unit 910 based on input information from a user. The input information may include current input information and historical input information. In some embodiments, the input information may exist in a form of a speech. The segmentation unit 910 may convert the speech into a text sentence by using ASR technologies. The ASR technologies may include End-to-End ASR, Hidden Markov Models (HMM)-based ASR, Dynamic Time Warping (DTW)-based ASR, Artificial Neural Network (ANN)-based ASR, etc. Each of the plurality of tokens may include one or more words.

The information extraction unit 920 may be configured to extract information from the plurality of tokens one by one. The information extraction unit 920 may determine an intention, a request, or an emotion of the user based on the extracted information.

The state determination unit 930 may be configured to determine a state of input information. The state determination unit 930 may generate a plurality of hidden states corresponding to the plurality of tokens. The hidden state corresponding to a current token may be generated based on the intention, request, or emotion of the user associated with the extracted information of the current token and a previously hidden state corresponding to a previous token. The hidden state of the last token may be designated as the state of the input information.

In some embodiments, the state of input information generated by the state determination unit 930 may include a state of current input information and a state of historical input information. In some embodiments, a state of current input information may include one or more current intentions or requests (e.g., a request for reminder service, ticket booking service), detailed information of the one or more current intentions or requests (e.g., detailed information about booking a ticket such as time, locations, personal preferences), emotion of the user (e.g., happy, sad, nervous), or the like, or any combination thereof. In some embodiments, a state of historical input information may include one or more historical intentions or requests of the user, detailed information of the one or more historical intentions or requests, historical emotion of the user, or the like, or any combination thereof.

It should be noted that the above description is merely provided for the purposes of illustration, and not intended to limit the scope of the present disclosure. For persons having ordinary skills in the art, multiple variations and modifications may be made under the teachings of the present disclosure. However, those variations and modifications do not depart from the scope of the present disclosure. For example, the dialogue state may be changed or updated during the progress of the dialogue. The state determination module 330 may change or update the dialogue state under multiple situations, including but not limited to obtaining new input information from the user, executing an action, and receiving a feedback message from the external device 130 in response to a request (e.g., booking a flight, controlling a smart device).

FIG. 10 is a flowchart of an exemplary process for determining a dialogue state based on input information from a user according to some embodiments of the present disclosure. The process 1000 may be executed by a component of the multi-task oriented dialogue system 100 (e.g. the server 110, the processing engine 112, the user device 120, the external device 130). In some embodiments, the process 1000 may be implemented as a set of instructions (e.g., an application) stored in the storage ROM 230 or RAM 240. The processor 220 may execute the set of instructions and may be configured to cause the computing device 200 (e.g., the server 110, the user device 120, the external device 130) to perform the process 1000.

In 1010, the communication module 310 may obtain input information from the user. The input information may exist in various forms including but not limited to speeches, texts, videos, pictures, etc. The input information may be provided via an input device of the user device 120 such as a microphone, a keyboard, a camera, a scanner, etc. Operation 1010 may be similar to operation 410 of the process 400 described elsewhere in this application and the description of operation 1010 is not repeated herein.

In 1020, the segmentation unit 910 may generate a sentence based on the input information. The sentence generated in operation 1020 may be in text form. In some embodiments, the input information may exist in a form of a speech, and accordingly operation 1020 may include recognizing the information in the speech by using automatic speech recognition (ASR) technologies. The speech may be converted into a text sentence by using the ASR technologies. The ASR technologies may include End-to-End ASR, Hidden Markov Models (HMM)-based ASR, Dynamic Time Warping (DTW)-based ASR, Artificial Neural Network (ANN)-based ASR, etc.

In 1030, the segmentation unit 910 may segment the sentence into a plurality of tokens. Each of the plurality of tokens may include one or more words. For example, a sentence “Lily plans to leave for Beijing tomorrow morning” may be segmented into five-tokens: “Lily,” “plans to,” “leave for,” “Beijing,” “tomorrow morning.”

In 1040, the segmentation unit 910 may order the plurality of tokens based on their positions in the sentence. For example, in the sentence “Lily plans to leave for Beijing tomorrow morning,” “Lily,” “plans to,” “leave for,” “Beijing,” and “tomorrow morning” are in the first, second, third, fourth, fifth position, respectively.

In 1050, the information extraction unit 920 may extract information of a token obtained and determine an intension, a request, or an emotion of the user based on the extracted information.

In 1060, the state determination unit 930 may generate or update a hidden state based on the intension, request, or emotion of the user. In some embodiments, the hidden state may be a tensor, such as a vector including the intension, request, or an emotion of the user.

In 1070, the information extraction unit 920 may determine whether the token is in the last position. If the token is not in the last position, the process 1000 may proceed to 1080, and the information extraction unit 920 may extract information of a token at a subsequent position of the plurality of tokens and determine an intension, a request, or an emotion of the user based on the extracted information of the token at the subsequent position. Then the process 1000 may proceed back to operation 1060 to update the hidden state based on the intension, request, or emotion of the user associated with the extracted information of the token at a subsequent position and the hidden state of a previous token. For example, the hidden state of “plans to” may be updated based on the extracted information of “plans to” and the hidden state of the “Lily.”

If the token is in the last position, the process 1000 may proceed to 1090, and the state determination unit 930 may generate a state of the input information based on the hidden state corresponding to the token. The hidden state of the last token may be designated as the state of the input information. For example, the state of the sentence “Lily plans to leave for Beijing tomorrow morning” may be obtained after the hidden state of “tomorrow morning” is determined based on the states of “tomorrow morning” and other tokens.

In some embodiments, the state of input information generated in operation 1090 may include a state of current input information and a state of historical input information. In some embodiments, a state of current input information may include one or more current intentions or requests (e.g., a request for reminder service, ticket booking service), detailed information of the one or more current intentions or requests (e.g., detailed information about booking a ticket such as time, locations, personal preferences), emotion of the user (e.g., happy, sad, nervous), or the like, or any combination thereof. In some embodiments, a state of historical input information may include one or more historical intentions or requests of the user, detailed information of the one or more historical intentions or requests, historical emotion of the user, or the like, or any combination thereof. The state determination unit 930 may determine whether there is any historical input information associated with the current input information. When there is no historical input information associated with the current input information, the state of current input information may be designated as the dialogue state. When there exists historical input information associated with current input information, the dialogue state may be determined based on both the state of current input information and state of historical input information.

In some embodiments, the determining of the dialogue state based on at least one state of input information may be implemented by one or more Artificial Neural Network (ANN) models such as a Convolutional Neural Network (CNN) model, a Recurrent Neural Network (RNN) model, etc.

It should be noted that the above description is merely provided for the purposes of illustration, and not intended to limit the scope of the present disclosure. For persons having ordinary skills in the art, multiple variations and modifications may be made under the teachings of the present disclosure. However, those variations and modifications do not depart from the scope of the present disclosure. For example, the dialogue state may be changed or updated during the progress of the dialogue. The state determination module 330 may change or update the dialogue state under multiple situations, including but not limited to obtaining new input information from the user, executing an action, and receiving a feedback message from the external device 130 in response to a request (e.g., booking a flight, controlling a smart device).

FIG. 11 is a flowchart of an exemplary process for executing one or more actions according to some embodiments of the present disclosure. The process 1100 may be executed by a component of the multi-task oriented dialogue system 100 (e.g. the server 110, the processing engine 112, the user device 120, the external device 130). In some embodiments, the process 1000 may be implemented as a set of instructions (e.g., an application) stored in the storage ROM 230 or RAM 240. The processor 220 may execute the set of instructions and may be configured to cause the computing device 220 (e.g., the server 110, the user device 120, the external device 130) to perform the process 1100.

In 1110, the execution module 350 may obtain the first action. The first action may be generated in operation 740 based on a dialogue state.

In 1120, the execution module 350 may execute the action. For a sentence-generating action, the execution module 350 may convert the sentence-generating action into a sentence with semantic and grammar rules that the user can understand. For an API-calling action, the execution module 350 may call a corresponding API to perform a specific task such as ordering, booking, shopping, etc.

In 1130, the execution module 350 may determine whether there is any unexecuted action. In some embodiments, in operation 420, the state determination module 330 may determine in each turn of the dialogue, two or more intentions implied in the input information received from the user, which relate to more than one task to be performed. In operation 440, the action generation module 340 may generate an action corresponding to each of the tasks. For example, in Table 4, the state determination module 330 may determine three intentions of the user: a schedule inquiry, a weather inquiry and a reminder of taking an umbrella, implied in the input information “If it rains, remind me to take an umbrella when I am going out.” The action generation module 340 may generate the action 1, action 2 and action 3. The execution module 350 may first obtain the action 1 in operation 1110 and execute the action 1 in operation 1120. After the action 1 is executed, the execution module 350 may determine whether there is any unexecuted action.

If there is an unexecuted action, the process 1100 may proceed to 1140, and the execution module 350 may generate a new action based on the execution result of the action. For example, in Table 4, the execution module 350 may execute the action 1 and find out that the user has a party at 11:00 a.m. today. The execution module 350 may generate the action 2 to check the weather at about 11:00 a.m. As another example, in Table 4, there may be two possible execution results of action 2: execution result A (i.e., it will rain during 10:00 a.m. to 12:00 a.m.) and execution result B (i.e., it's sunny today). The execution module 350 may generate action 3A and action 3B based on execution result A of the action 2 and execution result B of the action 2 respectively.

TABLE 4

| | |
|---|---|
| Turn 1: | “If it rains, remind me to take an umbrella |
| Input information | when I am going out.” |
| from the user | |
| Action 1 | An API-calling action for calling an API to |
| | look up the user's schedule to obtain the |
| | time when the user plans to go out. |
| Execution result | Find out that the user has a party at 11:00 |
| of action 1 | a.m. today. |
| Action 2 | An API-calling action for calling an API to |
| | check the weather at about 11:00 a.m. |
| Execution result | A: It will rain during 10:00 a.m. to 12:00 a.m. |
| of action 2 | B: It's sunny today. |
| Action 3 | A: An API-calling action for calling an API |
| | to remind the user to take an umbrella before |
| | 10:30 a.m. |
| | B: A sentence-generating action for |
| | generating a sentence to tell the user it's |
| | a sunny day. |
| Execution result | A: Record the event of reminding the user to |
| of action 3 | take an umbrella at 10:00 a.m. and 10:10 a.m. |
| | respectively |
| | B: Generate a sentence to tell the user it's |
| | a sunny day. |
| Turn 1: | A: “Will remind you twice at 10:00 a.m. and |
| Output information | 10:10 a.m. Shall I remind you one more time at |
| from the system | 10:20 a.m.?” |
| | B: “It's sunny today, you don't need |
| | to take an umbrella when you go out.” |
| Turn 2: | A: “One more time at 10:25 a.m.” |
| Input information | B: “OK” or no more input information |
| from the user | from the user. |
| Turn 2: | A: “OK, will remind you three times before |
| Output information | you go out, and wish you a wonderful party |
| from the system | today.” |
| | B: “Wish you a wonderful party today.” |

If there isn't any unexecuted action, the process 1100 may proceed to 1150, and the communication module 310 may transmit output information to the user based on the execution result of the action. For example, in Table 4, the execution module 350 may determine that no more actions is remaining after action 3A or action 3B is executed and the communication module 310 may transmit output information based on the execution result of action 3A or 3B (also referred to the execution result of the whole dialogue) to the user. For example, with respect to action 3A, the execution module 350 may generate two sentences “Will remind you twice at 10:00 a.m. and 10:10 a.m.” and “Shall I remind you one more time at 10:20 a.m.?” and transmit the two sentences to the user via, for example, the communication module 310. With respect to action 3B, the execution module 350 may generate a sentence “It's sunny today, you don't need take an umbrella when you go out” and transmit the sentence to the user via, for example, the communication module 310.

In 1160, the execution module 350 may determine whether the dialogue is finished. In some embodiments, there may be more than one turn of interaction in the dialogue between the user and the multi-task oriented dialogue system 100. As used herein, a turn of the interaction of a dialogue may refer to a situation that the user inputs information and the 100 outputs information in response to the input information from the user. The user may input more information in a new turn of the interaction of the dialogue or a new dialogue and the multi-task oriented dialogue system 100 may respond accordingly to generate a plurality of dialogues (or turns of dialogues). At the end of each turn, the execution module 350 may determine whether the dialogue is finished in operation 1160. In some embodiments, the one or more actions may include a release turn action. The release turn action may indicate either the user or the multi-task oriented dialogue system has finished its actions in a turn of the dialogue. For example, the release turn action may be generated by the multi-task oriented dialogue system 100 when the user has finished inputting information or the user replies nothing to the multi-task oriented dialogue system 100 for a preset timeout period. As another example, the release turn action may be generated when the multi-task oriented dialogue system 100 has executed all sentence-generating actions and API-calling actions in the turn of dialogue. In some embodiments, if two successive release turn actions are generated in a turn of a dialogue (e.g., indicating both the user and the multi-task oriented dialogue system 100 have finished their actions), the dialogue is finished. For example, in Table 4, after the communication module 310 outputs a sentence “Wish you a wonderful party today” to the user, a first release turn action may be generated to indicate that all sentence-generating actions and API-calling actions have been executed in turn 2. As the user replies nothing at all (e.g., no response in a preset timeout period), a second release turn action may be generated. As two successive release turn action, e.g., the first release turn action and the second release turn action, are generated, the execution module 350 may determine the dialogue is finished.

If the dialogue is finished, the process 1100 may proceed to 1170. In 1170, the discriminator unit 540 may valuate the finished dialogue. The finished dialogue may include all data generated during the whole dialogue such as the input information, dialogue states, one or more actions in response to the input information, execution results of the one or more actions, etc. The finished dialogue may be transmitted to the storage 150 via network 140. After the dialogue is finished, the discriminator unit 540 may valuate the finished dialogue based on criteria such as the completeness of one or more tasks in the finished dialogue, the performance of one or more tasks, the probability of the finished dialogue being a human dialogue, or the like, or any combination thereof. The method for valuating a dialogue can be found in FIG. 8 and is not repeated herein. If the dialogue is unfinished, the process 1100 may proceed to 1190.

In 1180, the dialogue generation unit 530 may update the dialogue model based on the valuation result. The process of updating the dialogue generation model based on valuation results may be implemented by using a Reinforcement Learning (RL) algorithm. The RL algorithm may include Dynamic Programming (DP), Temporal Differences (TD), Q-Learning, etc.

In 1190, the communication module 310 may transmit a request for new input information. For example, in Table 4, the multi-task oriented dialogue system 100 may determine to remind the user to take an umbrella twice at 10:00 a.m. and 10:10 a.m. but is not sure if it is necessary to remind the user one more time. Hence, the multi-task oriented dialogue system 100 may determine that the dialogue is unfinished and ask the user “Shall I remind you one more time at 10:20 a.m.?” for new input information. The process 1100 or a part of it may repeatedly be performed until the dialogue is finished and the process 1100 may proceed to 1170.

It should be noted that the above description is merely provided for the purposes of illustration, and not intended to limit the scope of the present disclosure. For example, the one or more actions may be executed one by one after all the one or more actions are generated, or one of the plurality of actions may be generated based on the execution result of a previous action. For persons having ordinary skills in the art, multiple variations and modifications may be made under the teachings of the present disclosure. However, those variations and modifications do not depart from the scope of the present disclosure.

To implement various modules, units, and their functionalities described in the present disclosure, computer hardware platforms may be used as the hardware platform(s) for one or more of the elements described herein. A computer with user interface elements may be used to implement a personal computer (PC) or any other type of work station or terminal device. A computer may also act as a server if appropriately programmed.

Having thus described the basic actions, it may be rather apparent to those skilled in the art after reading this detailed disclosure that the foregoing detailed disclosure is intended to be presented by way of example only and is not limiting. Various alterations, improvements, and modifications may occur and are intended to those skilled in the art, though not expressly stated herein. These alterations, improvements, and modifications are intended to be suggested by this disclosure and are within the spirit and scope of the exemplary embodiments of this disclosure.

Moreover, certain terminology has been used to describe embodiments of the present disclosure. For example, the terms “one embodiment,” “an embodiment,” and/or “some embodiments” mean that a particular feature, structure or characteristic described in connection with the embodiment is included in at least one embodiment of the present disclosure. Therefore, it is emphasized and should be appreciated that two or more references to “an embodiment” or “one embodiment” or “an alternative embodiment” in various portions of this specification are not necessarily all referring to the same embodiment. Furthermore, the particular features, structures or characteristics may be combined as suitable in one or more embodiments of the present disclosure.

Further, it will be appreciated by one skilled in the art, aspects of the present disclosure may be illustrated and described herein in any of a number of patentable classes or context including any new and useful process, machine, manufacture, or composition of matter, or any new and useful improvement thereof. Accordingly, aspects of the present disclosure may be implemented entirely hardware, entirely software (including firmware, resident software, micro-code) or combining software and hardware implementation that may all generally be referred to herein as a “unit,” “module,” or “system.” Furthermore, aspects of the present disclosure may take the form of a computer program product embodied in one or more computer readable media having computer readable program code embodied thereon.

A computer readable signal medium may include a propagated data signal with computer readable program code embodied therein, for example, in baseband or as part of a carrier wave. Such a propagated signal may take any of a variety of forms, including electro-magnetic, optical, or the like, or any suitable combination thereof. A computer readable signal medium may be any computer readable medium that is not a computer readable storage medium and that may communicate, propagate, or transport a program for use by or in connection with an instruction execution system, apparatus, or device. Program code embodied on a computer readable signal medium may be transmitted using any appropriate medium, including wireless, wireline, optical fiber cable, RF, or the like, or any suitable combination of the foregoing.

Computer program code for carrying out operations for aspects of the present disclosure may be written in any combination of one or more programming languages, including an object-oriented programming language such as Java, Scala, Smalltalk, Eiffel, JADE, Emerald, C++, C #, VB. NET, Python or the like, conventional procedural programming languages, such as the “C” programming language, Visual Basic, Fortran 2003, Perl, COBOL 2002, PHP, ABAP, dynamic programming languages such as Python, Ruby and Groovy, or other programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider) or in a cloud computing environment or offered as a service such as a Software as a Service (SaaS).

Furthermore, the recited order of processing elements or sequences, or the use of numbers, letters, or other designations, therefore, is not intended to limit the claimed processes and methods to any order except as may be specified in the claims. Although the above disclosure discusses through various examples what is currently considered to be a variety of useful embodiments of the disclosure, it is to be understood that such detail is solely for that purpose and that the appended claims are not limited to the disclosed embodiments, but, on the contrary, are intended to cover modifications and equivalent arrangements that are within the spirit and scope of the disclosed embodiments. For example, although the implementation of various components described above may be embodied in a hardware device, it may also be implemented as a software only solution, e.g., an installation on an existing server or mobile device.

1. A multi-task oriented dialogue system, the system comprising:
at least one storage device storing a set of instructions; and
at least one processor in communication with the at least one storage device, wherein when executing the set of instructions, the at least one processor is configured to cause the system to:
obtain input information from a user;
determine a dialogue state based on the input information;
obtain a dialogue model for generating one or more actions;
generate one or more actions based on the dialogue state and the obtained dialogue model;
execute the generated one or more actions, wherein the one or more actions include a sentence-generating action or an API-calling action; and
transmit output information to the user based on an execution result of the one or more actions.

2. The system of claim 1, wherein to determine the state of the input information, the at least one processor is configured to cause the system to:
segment the input information into a plurality of tokens; and
determine the dialogue state based on the plurality of tokens.

3. (canceled)

4. The system of claim 1, wherein the one or more actions each includes a name.

5. The system of claim 4, wherein the one or more actions each further includes at least one slot-pair.

6. (canceled)

7. The system of claim 1, wherein the dialogue model for generating one or more actions is generated by a process of training a model, the process comprising:
obtaining a preliminary model;
obtaining training data from a dialogue corpus;
generating actions based on the training data;
generating a dialogue model by training the preliminary model based on the actions;
generating simulated dialogues based on the dialogue model;
valuating the generated simulated dialogues; and
updating the dialogue model based on a result of the valuation.

8. The system of claim 1, wherein the at least one processor is further configured to cause the system to update the dialogue model after a dialogue between the multi-task oriented dialogue system and the user is finished.

9. The system of claim 8, wherein to update the dialogue model after the dialogue between the multi-task oriented dialogue system and the user is finished, the at least one processor is further configured to cause the system to:
obtain the finished dialogue between the multi-task oriented dialogue system and the user;
perform a first valuation on completeness of one or more tasks in the finished dialogue;
perform a second valuation on performance of the one or more tasks in the finished dialogue;
perform a third valuation on a probability of the finished dialogue being a human dialogue;
determine a valuation result based on the first valuation, the second valuation, and the third valuation; and
update the dialogue model based on the valuation result.

10. The system of claim 1, wherein to execute the generated one or more actions, the at least one processor is configured to cause the system to:
execute the generated one or more actions in a sequence, the one or more actions including a first action and a second action, wherein:
the first action is executed before the second action, and
the second action is executed based on an execution result of the first action.

11. The system of claim 1, wherein the output information includes a request for obtaining new input information in a new turn.

12. A method performed by a multi-task oriented dialogue system for conducting a multi-task oriented dialogue, the method comprising:
obtaining input information from a user;
determining a dialogue state based on the input information;
obtaining a dialogue model for generating one or more actions;
generating one or more actions based on the dialogue state and the obtained dialogue model;
executing the generated one or more actions, wherein the one or more actions include a sentence-generating action or an API-calling action; and
transmitting output information to the user based on an execution result of the one or more actions.

13. The method of claim 12, wherein the determining the state of the input information comprises:
segmenting the input information into a plurality of tokens; and
determining the dialogue state based on the plurality of tokens.

14-17. (canceled)

18. The method of claim 12, wherein the dialogue model for generating one or more actions is generated by a process of training a model, the process comprising:
obtaining a preliminary model;
obtaining training data from a dialogue corpus;
generating actions based on the training data;
generating a dialogue model by training the preliminary model based on the actions;
generating simulated dialogues based on the dialogue model;
valuating the generated simulated dialogues; and
updating the dialogue model based on a result of the valuation.

19. The method of claim 12, further comprising updating the dialogue model after a dialogue between the multi-task oriented dialogue system and the user is finished.

20. The method of claim 19, wherein the updating the dialogue model after the dialogue between the multi-task oriented dialogue system and the user is finished comprises:
obtaining the finished dialogue between the multi-task oriented dialogue system and the user;
performing a first valuation on completeness of one or more tasks in the finished dialogue;
performing a second valuation on performance of the one or more tasks in the finished dialogue;
performing a third valuation on a probability of the finished dialogue being a human dialogue;
determining a valuation result based on the first valuation, the second valuation, and the third valuation; and
updating the dialogue model based on the valuation result.

21. The method of claim 12, wherein the executing the generated one or more actions comprises:
executing the generated one or more actions in a sequence, the one or more actions including a first action and a second action, wherein:
the first action is executed before the second action, and
the second action is executed based on an execution result of the first action.

22. (canceled)

23. A non-transitory computer readable medium comprising executable instructions that, when executed by at least one processor, cause the at least one processor to effectuate a method, the method comprising:
obtaining input information from a user;
determining a dialogue state based on the input information;
obtaining a dialogue model for generating one or more actions;
generating one or more actions based on the dialogue state and the obtained dialogue model;
executing the generated one or more actions, wherein the one or more actions include a sentence-generating action or an API-calling action; and
transmitting output information to the user based on an execution result of the one or more actions.

24. The system of claim 7, wherein the generating the simulated dialogues based on the dialogue model comprises:
obtaining a human dialogue;
deleting part of the human dialogue; and
complete the human dialogue based on the dialogue model to generate the simulated dialogue.

25. The system of claim 7, wherein the valuation of the generated simulated dialogue is implemented by a value model, wherein the dialogue model and the value model are combined into a Generative Adversarial Network (GAN) model.

26. The system of claim 1, wherein the at least one processor is further configured to cause the system to:
determine whether two successive release turn actions are generated in a turn of a dialogue between the multi-task oriented dialogue system and the user; and
in response to a determination that two successive release turn actions are generated in a turn of a dialogue between the multi-task oriented dialogue system and the user,
determine that the dialogue ends, and
terminate the dialogue.

27. The system of claim 1, wherein the dialogue state relates to an intention or an emotion of the user.
